(19) United States
(12) Patent Application Publication
(10) Pub. No.: US 2022/0111290 A1
(43) Pub. Date: Apr. 14, 2022

(54) HAPTIC ENGINE FOR SPATIAL COMPUTING

(71) Applicant: CONTACT CONTROL INTERFACES, LLC, West Chester Township, OH (US)

(72) Inventors: Thomas Buchanan, IV, Cincinnati, OH (US); Zachary Schroeder, Liberty Twp, OH (US); John Schroeder, III, West Chester, OH (US); Craig Douglass, Cincinnati, OH (US)

(21) Appl. No.: 17/066,577

(22) Filed: Oct. 9, 2020

(51) Int. Cl. A63F 13/285; G06F 3/01

(52) U.S. Cl. CPC A63F 13/285; G06F 2203/013; G06F 3/016; G06F 3/014

(57) ABSTRACT

A method comprises receiving data from a game engine associated with one or more virtual interactions in a virtual world, determining a haptic response based on the virtual interactions, and outputting a signal to a haptic device to cause the haptic device to create the haptic response

### TECHNICAL FIELD

The present specification relates to software interfaces for haptic device and, more particularly, to a haptic engine for spatial computing.

### BACKGROUND

The virtual reality experience industry has seen many changes over the years. As computing power has expanded, developers of virtual reality or spatial computing experiences have likewise created games and other software that take advantage of these increases in computing power. To this end, game developers have been coding experiences that incorporate sophisticated operations and mathematics to produce a realistic and immersive experience.

One type of immersive virtual reality experience involves a glove or other wearable or non-wearable device that a user may wear or otherwise use to control a virtual hand or other aspects of a virtual character in a virtual world. The user may then perform physical actions in the real world while wearing the device that may be mimicked by the virtual character in the virtual world.

In one example, the user may wear a glove and may perform motions with their hand that may cause a virtual hand of the virtual character in the virtual world to perform similar actions. In particular the user may perform actions while wearing the glove to cause the virtual character to perform certain actions with respect to virtual objects in the virtual world, such as picking up or dropping objects. As the virtual character interacts with virtual objects in the virtual world, the glove may provide haptic feedback to the user to further enhance the immersive experience.

Game developers often utilize a game engine, such as Unity or Unreal, to develop games. Game engines provide a framework and a number of tools that developers may use when developing games. Game engines typically include a physics engine that handles physics of virtual objects in a game or virtual world. Thus, a game developer may create virtual objects using the game engine and assign properties to those objects, and the game engine will handle the physics regarding motion of the objects and interactions between various objects in the virtual world. However, game engines do not typically offer support for haptic devices. Accordingly, if a game developer wishes to incorporate a haptic device into a game and provide haptic feedback to the haptic device, the developer may be required to create a substantial amount of code to cause haptic feedback with the device based on virtual interactions. Therefore, there is a need for a software layer that manages haptics for a haptic device.

### SUMMARY

In one embodiment, a method includes receiving data from a game engine associated with one or more virtual interactions in a virtual world, determining a haptic response based on the virtual interactions, and outputting a signal to a haptic device to cause the haptic device to create the haptic response.

In another embodiment, a method includes receiving first data from a game engine, the first data comprising data from one or more colliders associated with a virtual hand in a virtual world and determining whether the virtual hand is making contact with a virtual object in the virtual world based on the first data. When it is determined that the virtual hand is making contact with the virtual object, the method includes determining a haptic response based on the first data and one or more parameters associated with the virtual object and outputting second data to cause a wearable haptic device to create the haptic response.

In another embodiment, a system includes a haptic device, a game engine, a haptic engine plugin, a haptic engine, one or more processors, one or more memory modules, and machine readable instructions stored in the one or more memory modules. When executed by the one or more processors, the memory modules cause the haptic engine to receive data from the game engine associated with one or more virtual interactions in a virtual world based on data transmitted from the game engine to the haptic engine plugin, determine a haptic response based on the virtual interactions, and output a signal to the haptic device to cause the haptic device to create the haptic response.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an example system for a wearable haptic device that may be used to interact with a gaming system, according to one or more embodiments shown and described herein;

FIG. 2 depicts a schematic diagram of an example gaming system, according to one or more embodiments shown and described herein;

FIG. 3 depicts an example method of operating a haptic engine of the gaming system of FIG. 2, according to one or more embodiments shown and described herein;

FIG. 4 depicts another example method of operating a haptic engine of the gaming system of FIG. 2, according to one or more embodiments shown and described herein; and

FIG. 5 depicts another example method of operating a haptic engine of the gaming system of FIG. 2, according to one or more embodiments shown and described herein.

### DETAILED DESCRIPTION

The embodiments disclosed herein describe a haptic engine for spatial computing that may be used with a game engine to provide a haptic response to a wearable or non-wearable haptic device based on interactions that occur in a virtual world. A game engine is a software platform that may be utilized by game developers to create games and/or other interactive software. Examples of game engines include Unity and Unreal, among others. A game engine may allow a game developer to create virtual reality games and other immersive experiences. A virtual reality game or experience may include a virtual world that a player may explore by controlling one or more aspects of a virtual character in the virtual world. Such a virtual experience is sometimes referred to as spatial computing.

The virtual world may be presented to a player through three-dimensional graphics. As the player moves a virtual character through the virtual world, the character may encounter virtual objects that may be interacted with. These interactions may be managed by the game engine, which may have a physics engine to determine realistic physics for the objects in the game. Thus, the game engine may handle the physics relating to interactions (e.g., collisions) between objects in the virtual world.

The game engine may handle collisions between objects in the virtual world through the use of colliders. Colliders are software components that game developers may attach to virtual objects in a game or virtual world. Once a collider is attached to an object, the game engine tracks the position of the collider to determine when collisions with other objects occur. That is, when a volume of a first collider of a first object and a volume of a second collider of a second object intersect, the game engine determines that a collision has occurred between the first and second objects. Once a collision occurs, the game engine may determine the subsequent movement of the objects based on properties of the objects (e.g., the shapes of the colliders, the material properties of the colliders, etc.) and the conditions of the collision (e.g., the speed of the colliders at the time of the collision, the direction of movement of the colliders, etc.).

When a collision occurs between a virtual character and a virtual object, the game engine may return data associated with the collision. The game engine may then determine how the game should proceed based on the collision. In addition, if a user is using a wearable or non-wearable haptic device to control aspects of the game, game developers may desire the haptic device to provide haptic feedback when the virtual character interacts with certain virtual objects in the game. For example, when the character touches an object, the haptic device may provide force feedback or other haptic responses to the user wearing or using the haptic device. This may improve the immersive experience of the user by simulating a sensation for the user that may be experienced by the virtual character.

In order for a game to provide haptic feedback to a haptic device, game developers may add components or other software to the game using a game engine that may determine specific output signals to send to the haptic device to cause particular haptic responses depending on the interactions that occur in the virtual world of the game. However, this may require a significant amount of code to be implemented and managed by the game developers. Accordingly, disclosed herein is a haptic engine that may be implemented as an interface layer between the game engine and a haptic device.

In particular, the haptic engine disclosed herein may be used with a game engine to manage haptics for a haptic device used with a game or virtual world created with a game engine. The haptic engine may receive collider data associated with collisions or other virtual interactions between a virtual character and virtual objects in a game or virtual world. The haptic engine may determine a haptic response to be produced by the haptic device based on the virtual interactions. The haptic engine may then output a signal to the haptic device to cause the haptic device to create the haptic response. Game developers may set certain haptic parameters of virtual objects to determine the types of haptic responses to be produced. Thus, game developers may use the haptic engine disclosed herein to manage haptics for a haptic device.

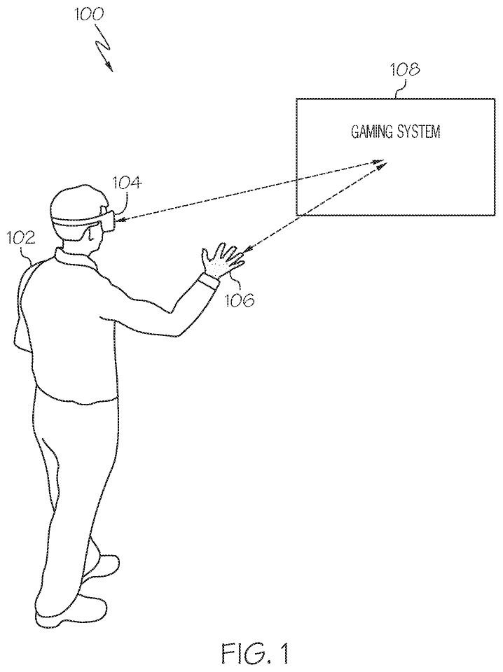

Referring now to the drawings, FIG. 1 depicts an illustrative system 100 for implementing a virtual reality experience, according one or more embodiments shown and described herein. In the example of FIG. 1, a user or player 102 wears a headset 104 and a haptic glove 106. The headset 104 and the haptic glove 106 are functionally coupled to a gaming system 108. In some examples, the headset 104 and the haptic glove 106 may be connected to the gaming system 108 through a wired connection. In other examples, the headset 104 and the haptic glove 106 may be connected to the gaming system 108 through a wireless connection. In some examples, the components of the gaming system 108 may be incorporated into the headset 104. While the example of FIG. 1 illustrates the player 102 wearing a haptic glove 106, in other examples, the system 100 may include any other wearable or non-wearable device that the user 102 may wear or otherwise use to control one or more aspects of a virtual character, as disclosed herein.

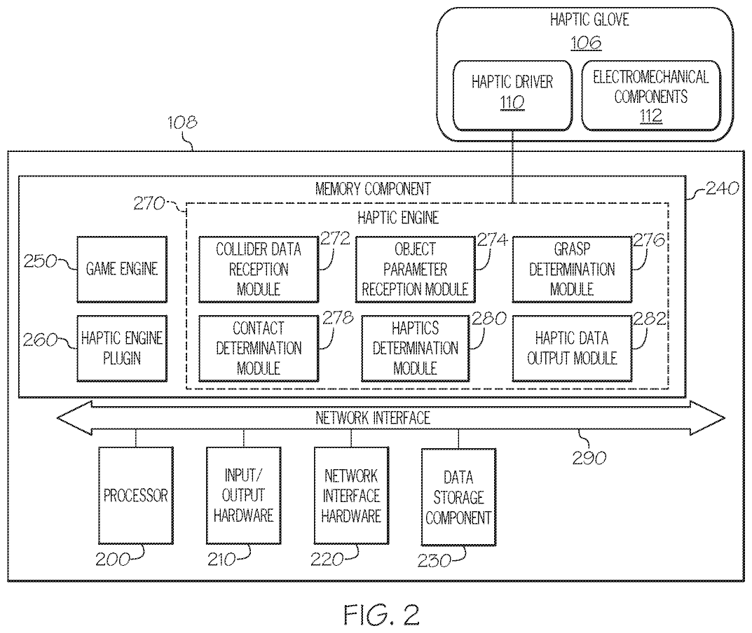

In the example of FIG. 1, the gaming system 108 comprises a hardware system running gaming or other software that operates a virtual reality game or immersive experience. Specifically, the gaming system 108 creates a virtual world that the user 102 may interact with, as disclosed herein. The hardware system of the gaming system 108 may comprise a personal computer, a gaming console, or other specialized hardware. The gaming system 108 may receive signals from the headset 104 and/or the haptic glove 106 and may send signals to the headset 104 and/or the haptic glove 106 as described herein. Details of the gaming system 108 are discussed further below in connection with FIG. 2.

The haptic glove 106 may be worn by the user 102 and may be used to interact with a virtual world created by the gaming system 108 (e.g., by controlling one or more aspects of a virtual character). In the example of FIG. 1, the user 102 may move their hand while wearing the haptic glove 106 to control the hand of a virtual character in the virtual world created by the gaming system 108. As such, the user 102 may use their hand to cause the virtual character to interact with objects in the virtual world of the gaming system 108 as described herein. While in the example of FIG. 1, the user 102 interacts with the virtual world of the gaming system 108 through the haptic glove 106, in other examples, the user 102 may interact with the virtual world of the gaming system 108 through other controllers or one or more other wearable devices.

In the example of FIG. 1, the system 100 tracks the position and orientation of the haptic glove 106 as it is worn by the user 102. The position and orientation of the haptic glove 106 may be transmitted to the gaming system 108 and the gaming system 108 may utilize the received position and orientation of the haptic glove 106 to control interactions in the virtual world. For example, as the user 102 moves their hand in a certain manner, the gaming system 108 may cause the hand of the character in the virtual world to be moved in a similar manner. As the user 102 moves their fingers into a particular pose, the gaming system 108 may cause the hand and fingers of the character in the virtual world to be moved to a similar pose. Thus, the user 102 may feel as though they are immersed in the virtual world of the gaming system 108.

In some examples, a position of the user's hand may be tracked. In the illustrated example, the user's hand is tracked by a camera that is part of the headset 104. In other examples, the user's hand may be tracked by an external camera (not shown in FIG. 1). In some examples, the haptic glove 106 may have sensors attached thereto to track the movement of the hand of the user 102. In some examples, the system 100 may track the hand of the user 102 through a combination of cameras and/or sensors. It should be understood that any method of tracking the user's hand may be used.

In the example of FIG. 1, the haptic glove 106 may provide haptic feedback to the user 102. Specifically, the haptic glove 106 may provide vibration, force feedback, pressure, temperature changes, or other physical sensations to the fingers and/or palm of the user 102. Accordingly, the haptic glove 106 may provide a more immersive experience to the user 102 as the user 102 interacts with the virtual world. For example, when the virtual character controlled by the user 102 touches an object in the virtual world, the gaming system 108 may cause the haptic glove 106 to provide haptic feedback to the user 102 to simulate for the user 102 the feeling of touching the object that may be experienced by the virtual character. The type of haptic feedback provided by the haptic glove 106 may be based on the specific interactions occurring in the virtual world as controlled by the gaming system 108. In some examples, another wearable device or a non-wearable device may be used and tracked rather than the haptic glove 106.

In the example of FIG. 1, the headset 104 worn by the user 102 tracks the gaze of the user 102 and may comprise a display to display the virtual world of the gaming system 108 to the user 102. The image displayed to the user 102 of the virtual world may depend on the gaze of the user 102 tracked by the headset 104. For example, if the user 102 turns their head to the left, the headset 104 may display an image to the left of the character in the virtual world. If the user 102 looks down, the headset 104 may display the ground in front of the character in the virtual world. In some examples, the headset 104 may only track the gaze of the user 102 and an image of the virtual world of the gaming system 108 may be displayed on an external display (e.g., a computer monitor or television). In addition, as explained above, in some examples, the headset 104 may track the motion of the hand of the user 102 wearing the haptic glove 106.

Turning now to FIG. 2, additional details regarding the haptic glove 106 and gaming system 108 are depicted. As illustrated in FIG. 2, the haptic glove 106 includes a haptic driver 110 and electro-mechanical components 112. The haptic driver 110 receives signals from the gaming system 108 to cause the haptic glove 106 to produce a haptic response. The electro-mechanical components 112 are actuated to produce a haptic response in the haptic glove 106 based on the signals received by the haptic driver 110. The haptic driver 110 and the electro-mechanical components 112 are discussed in further detail below.

The gaming system 108 may include a processor 200, input/output hardware 210, network interface hardware 220, a data storage component 230, and a non-transitory memory component 240. The memory component 240 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store a game engine 250, a haptic engine plugin 260, and a haptic engine 270. A network interface 290 is also included in FIG. 2 and may be implemented as a bus or other interface to facilitate communication among the components of the gaming system 108.

The processor 200 may include any processing component configured to receive and execute instructions (such as from the data storage component 230 and/or memory component 240). The input/output hardware 210 may include a monitor, keyboard, mouse, printer, camera, microphone, speaker, touch-screen, and/or other device for receiving, sending, and/or presenting data. The network interface hardware 220 may include any wired or wireless networking hardware, such as a modem, LAN port, wireless fidelity (Wi-Fi) card, WiMax card, mobile communications hardware, and/or other hardware for communicating with other networks and/or devices such as the headset 104 and/or the haptic glove 106.

It should be understood that the data storage component 230 may reside local to and/or remote from the gaming system 108 and may be configured to store one or more pieces of data for access by the gaming system 108 and/or other components. The data storage component 230 of FIG. 2 may store data to be accessed by the game engine 250, the haptic engine plugin 260, and/or the haptic engine 270.

The game engine 250 comprises a software platform for game development, such as Unity or Unreal. While the Unity and Unreal game engines are mentioned as exemplary game engines, it should be understood that the game engine 250 may comprise any game engine. The game engine 250 provides a framework that game developers may use to create interactive virtual reality games or experiences. The game engine 250 may allow game developers to create a virtual world through sounds and three-dimensional graphics. Virtual objects may be placed in the virtual world and the user 102 may interact with the virtual world and the objects therein. The game engine 250 may have a physics engine that controls the motion of objects based on realistic physics.

The game engine 250 may allow colliders to be placed on objects in the virtual world. Colliders are software components that may allow for collisions between objects. If two objects that do not have any colliders placed on them collide with each other in the virtual world, the objects may simply pass through each other. However, if two objects with colliders attached to them collide with each other in the virtual world, the game engine 250 may recognize that a collision has occurred between the objects and may take certain actions in the game depending on attributes assigned to the colliders involved in the collision.

The game engine 250 may allow at least two types of colliders to be placed on objects. The first type of collider is a normal collider. When a normal collider collides with another collider (e.g., the volumes of the two colliders intersect), the game engine 250 recognizes that a collision has occurred and returns data associated with the collision. However, the object with the normal collider does not react to the collision. Alternatively, another type of collider is a rigid body collider. When a rigid body collider collides with another object, the game engine 250 returns data associated with the collision and also causes the object to which the rigid body is attached to react based on the physics engine (e.g., the object may bounce off of the object it collides with). The specific reaction of the object to the collision may be based on the properties of the objects involved in the collision, as specified in the colliders (e.g., mass, shape, and the like).

The game engine 250 may also allow for the use of colliders with different shapes. Exemplary colliders include a sphere collider, a box collider, and a capsule collider, having respective shapes of a sphere, a box, and a capsule. The game engine 250 may also allow for the use of compound and/or mesh colliders, which have more complex shapes and may more closely match the shape of an object.

The game engine 250 may also allow game developers to create a virtual character in the virtual world having one or more aspects that may be controlled by the user 102. In the illustrated example, a virtual character may be at least partly controlled by the user 102 through the use of the haptic glove 106. In some examples, the user 102 may move their hand while wearing the haptic glove 106 to control the movement of the hand of the virtual character in the virtual world. As explained above, the system 100 may track the motion of the haptic glove 106 being worn by the user 102 and may transmit the tracking information to the game engine 250. The game engine 250 may then cause the virtual character to move or otherwise behave based on the received tracking information. In other examples, aspects of the virtual character may be controlled by other controllers and/or wearable devices worn by the user 102.

In order for the virtual character to interact with objects in the virtual world, colliders must be placed on the virtual character. When colliders are placed on the virtual character, the game engine 250 may determine when the virtual character collides with other virtual objects that have colliders placed on them. The game engine 250 may then return data associated with the colliders involved in the collision (e.g., the speed and acceleration of the colliders, the angle of approach of the colliders, how colliders contacted each other, and the like). In particular, when the virtual character collides with other virtual objects, the game engine 250 may transmit collider data to the haptic engine plugin 260 to handle haptics associated with the collision, as disclosed herein.

The haptic engine plugin 260 receives collider data from the game engine 250 and converts the collider data to a format understood by the haptic engine 270. Different game engines may output different types of collider data in different data formats. Thus, in order for a single haptic engine 270 to work with any game engine, the haptic engine plugin 260 is used for a specific game engine 250. For example, one haptic engine plugin 260 may be used with the Unity game engine 250 and another haptic engine plugin 260 may be used with the Unreal game engine 250. As such, the same haptic engine 270 may be utilized in the gaming system 108 with any game engine 250.

In particular, the haptic engine plugin 260 may receive collider data from the game engine 250 in a format particular to the specific game engine 250 and may output the collider data in a format particular to the haptic engine 270. The collider data received by the haptic engine plugin 260 from the game engine 250 may include collider data associated with a virtual object and a virtual character when one or more colliders of the virtual object collider with one or more colliders of the virtual character. The collider data received by the haptic engine plugin 260 may include which colliders are involved in the collision, the speed of the colliders involved in the collision, parameters of the colliders involved in the collision, and the like. In embodiments, the game engine 250 may output collider data to the haptic engine plugin 260 every frame of the game. In other examples, the game engine 250 may output collider data to the haptic engine plugin 260 fewer than once every frame of the game.

The haptic engine plugin 260 outputs the data associated with the colliders involved in the collision to the haptic engine 270 in a format understood by the haptic engine 270. In some examples, the gaming system 108 may not include the haptic engine plugin 260. In these examples, the game engine 250 may transmit collider data directly to the haptic engine 270.

In addition to collider data, the haptic engine plugin 260 may also receive haptic parameters from the game engine 250. The haptic engine plugin 260 may then convert the haptic parameters to a format understood and transmit the converted haptic parameters to the haptic engine 270. Haptic parameters are discussed in further detail below.

Referring still to FIG. 2, the haptic engine 270 comprise a collider data reception module 272, an object parameter reception module 274, a grasp determination module 276, a contact determination module 278, a haptics determination module 280, and a haptic data output module 282. In some examples, each of the collider data reception module 272, the object parameter reception module 274, the grasp determination module 276, the contact determination module 278, the haptics determination module 280, and the haptic data output module 282 may comprise a separate script or component. In some examples, one or more of the collider data reception module 272, the object parameter reception module 274, the grasp determination module 276, the contact determination module 278, the haptics determination module 280, and the haptic data output module 282 may be combined in a single script or components. In some examples, one or more of the collider data reception module 272, the object parameter reception module 274, the grasp determination module 276, the contact determination module 278, the haptics determination module 280, and the haptic data output module 282 may comprise multiple scripts or components.

The collider data reception module 272 may receive collision data from the haptic engine plugin 260. In the illustrated example, the collider data reception module 272 may receive collision data from the haptic engine plugin 260 associated with colliders on a virtual hand of a virtual character in a virtual world created by the game engine 250. Colliders may be placed at various locations on the virtual hand of the virtual character including on the fingers, fingertips, knuckles, and/or palm of the virtual hand. In other examples, colliders may be placed at other locations on the virtual character.

In embodiments, any time there is a collision between any of the colliders on the virtual hand of the virtual character and a collider of an object in the virtual world, the game engine 250 may transmit data associated with this collision to the haptic engine plugin 260. The haptic engine plugin 260 may then convert the collider data to an appropriate format and transmit the converted collider data to the collider data reception module 272. The data associated with the collision received by the collider data reception module 272 may comprise the speed of the colliders at the time of the collision, the angle of the collision, the position of the objects involved in the collision, and the like. In some examples, the collider data reception module 272 may receive data associated with the colliders on the virtual hand of the virtual character even when no collision occurs with objects in the virtual world.

The object parameter reception module 274 receives parameter data or metadata associated with objects that collide with the virtual hand of the virtual character. In particular, the object parameter reception module 274 may receive haptic parameters associated with objects in the virtual world. In some examples, haptic parameters associated with objects in a collision are transmitted from the game engine 250 to the haptic engine plugin 260 and then transmitted from the haptic engine plugin 260 to the object parameter reception module 274 in an appropriate format. In other examples, haptic parameters are transmitted directly from the game engine 250 to the object parameter reception module 274.

In embodiments, any time there is a collision between any of the colliders on the virtual hand of the virtual character and a collider of an object in the virtual world, the game engine 250 may transmit data comprising one or more values of haptic parameters associated with the object to the haptic engine plugin 260 or directly to the object parameter reception module 274. These haptic parameters may be set by game developers to trigger a haptic response in the haptic glove 106. In some examples, the haptic parameters of an object may indicate one or more haptic responses that should occur when the virtual hand of the virtual character touches the object. For example, a haptic parameter of an object may indicate that the haptic glove 106 should vibrate, change temperature, and/or apply pressure or force feedback when the virtual hand touches the object.

In other examples, the haptic parameters of an object may be associated with the type of the object or particular properties of the object rather than specific haptic responses. These haptic parameters may comprise one or more user definable material properties of the object and may represent a feel of the object to be replicated by the haptic glove 106. For example, the haptic parameters may indicate how hard or soft the object is, how hot or cold the object is, the texture of the object, and the like. In this manner, a game developer may set haptic parameters of objects in the virtual world that the game developer desires to create a haptic response when they are interacted with by the virtual hand of a virtual character. This may involve the game developer selecting desired properties of the objects (e.g., hardness, texture, temperature, and the like). The haptic engine 270 may then handle the haptics for the haptic glove 106 without any additional coding required by the game developer, as disclosed herein. As such, game developers may easily integrate haptics into their game or virtual world without the need to learn details regarding the haptic glove 106 or the haptic driver 110. Rather, a game developer may merely set haptic parameters of any objects that are desired to produce a haptic response and the haptic engine 270 manages all the haptics for a haptic device.

The grasp determination module 276 determines whether the virtual hand of the virtual character is grasping or holding an object based on the collider data received by the collider data reception module 272. In embodiments, the haptic glove 106 may output a particular haptic response when the virtual hand is holding an object. As such, the grasp determination module 276 may determine if the virtual hand is holding an object such that this type of haptic response may be produced.

The contact determination module 278 determines whether the virtual hand of the virtual character is making contact with an object without the virtual hand holding the object based on the collider data received by the collider data reception module 272. In embodiments, the haptic glove 106 may output a particular haptic response when the virtual hand is contacting an object. As such, the contact determination module 278 may determine if the virtual hand is holding an object such that this type of haptic response may be produced.

In particular, the contact determination module 278 may determine what portion of the virtual hand of the virtual character is contacting an object based on which colliders of the virtual hand are in contact with object colliders. For example, the contact determination module 278 may determine that particular fingers of the virtual hand are contacting an object or that the palm of the hand is contacting an object. The haptic engine 270 may then cause the haptic glove 106 to produce an appropriate haptic response based on which portion of the virtual hand is contacting an object, as disclosed herein. For example, if only the thumb of the virtual hand is contacting an object in the virtual world, the haptic engine 270 may cause a haptic response to be produced on just the thumb of the haptic glove 106.

In embodiments, the contact determination module 278 may determine whether the fingers of the virtual hand or the palm of the virtual hand are touching a virtual object. In some examples, particular haptic responses may be produced when the fingers of the virtual hand are touching an object and other haptic responses may be produced when the palm of the virtual hand is touching an object.

The haptics determination module 280 determines a particular haptic response to be produced by the haptic glove 106 based on the collider data received by the collider data reception module 272, the haptic parameters received by the object parameter reception module 274, and the determinations made by the grasp determination module 276 and the contact determination module 278. In examples where the object parameter reception module 274 receives parameters associated with one or more particular haptic responses, the haptics determination module 280 determines that the haptic response to be produced by the haptic glove 106 corresponds to the one or more haptic responses received by the object parameter reception module 274.

In examples, where the haptic parameters received by the object parameter reception module 274 comprise particular properties of the object, the haptics determination module 280 may determine a haptic response based on the properties of the object. For example, if the object has a particular temperature, the haptics determination module 280 may determine that the haptic glove 106 should produce a temperature change. If the object has a particular hardness, the haptics determination module 280 may determine that the haptic glove 106 should produce pressure to simulate the hardness of the object. If the object has a particular texture, the haptics determination module 280 may determine that the haptic glove 106 should produce a particular vibration to simulate the texture of the object. In embodiments, the haptics determination module 280 may determine a particular haptic response to be produced by the haptic glove 106 for each parameter received by the object parameter reception module 274.

In the illustrated example, the haptic glove 106 is able to produce vibration, force feedback, pressure, and temperature change. Each of these responses may be produced by the electro-mechanical components 112 actuating in a certain manner to produce the desired haptic response. However, it should be understood that in other examples, the haptic glove 106 may produce other types of haptic responses. In the illustrated example, the haptic glove 106 is able to produce a haptic response at each of the fingers and/or the palm of the haptic glove 106. However, it should be understood that in other examples, the haptic glove 106 may also produce a haptic response at other portions of the haptic glove 106. Furthermore, as explained above, in some examples, another wearable or non-wearable haptic device may be utilized in place of the haptic glove 106. In these examples, other haptic responses may be produced by the haptic device according to the shape, size, and other properties of the haptic device.

In the illustrated example, the haptics determination module 280 may determine a haptic response to be produced for each finger and the palm of the haptic glove 106 based on the collider data received by the collider data reception module 272. For example, if certain fingers or portions of the virtual hand are contacting an object in the virtual world, the haptics determination module 280 may determine that the corresponding fingers or portions of the haptic glove 106 will determine an appropriate haptic response.

In embodiments, after the haptics determination module 280 determines a haptic response to be produced by the haptic glove 106, the haptic data output module 282 may output a signal to the haptic driver 110 to cause the haptic glove 106 to create the determined haptic response. As explained above, the haptic data output module 282 may output a signal to cause each finger and the palm of the haptic glove 106 to produce a particular haptic response. In embodiments, the haptic driver 110 of the haptic glove 106 is specific to the particular haptic glove 106 and may receive the signal output by the haptic data output module 282 and cause the electro-mechanical components 112 of the haptic glove 106 to actuate in an appropriate manner to cause the haptic glove 106 to produce the desired haptic response.

Any haptic driver 110 of a haptic device (e.g., the haptic glove 106) may receive a signal from the haptic data output module 282 and be able to interpret the signal and cause the appropriate electro-mechanical components 112 to actuate to cause the haptic glove 106 to produce the appropriate haptic response. Thus, the same haptic engine 270 may be used for any haptic glove 106 hardware and may output the same signal specifying a haptic response to be produced by any haptic glove 106 hardware. The haptic driver 110 then causes the causes the electro-mechanical components 112 to produce the desired response. As such, the haptic data output module 282 need not output a different signal depending on the particular haptic glove 106 hardware being used.

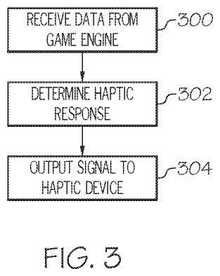

FIG. 3 depicts a flowchart of an example method of operating the haptic engine 270, according to one or more embodiments shown and described herein. At step 300, the collider data reception module 272 receives data from the game engine 250 associated with one or more virtual interactions in a virtual world. In some examples, the collider data reception module 272 receives data from the haptic engine plugin 260 after the haptic engine plugin 260 receives data from the game engine 250 and converts the data to an appropriate format to be understood by the haptic engine 270.

The virtual interactions in the virtual world may comprise a collision between a virtual hand and a virtual object. The data received from the game engine 250 may comprise data from one or more colliders associated with a virtual hand in the virtual world. The object parameter reception module 274 may receive data from the game engine 250 or the haptic engine plugin 260 comprising metadata or haptic parameters associated with a virtual object in the virtual world. The metadata associated with the virtual object may comprise one or more material properties of the object.

At step 302, the haptics determination module 280 determines a haptic response based on the virtual interactions. Then, at step 304, the haptic data output module 282 outputs a signal to the haptic glove 106 to cause the haptic glove 106 to create the haptic response. The haptic response may comprise vibration, force feedback, applying a temperature or temperature change, or causing the haptic glove 106 to apply pressure to a wearer of the haptic glove 106 at one or more points on the haptic glove 106. The signal output by the haptic glove 106 may cause the haptic glove 106 to create the haptic response on one or more fingers of the haptic glove 106 and/or on a palm of the haptic glove 106.

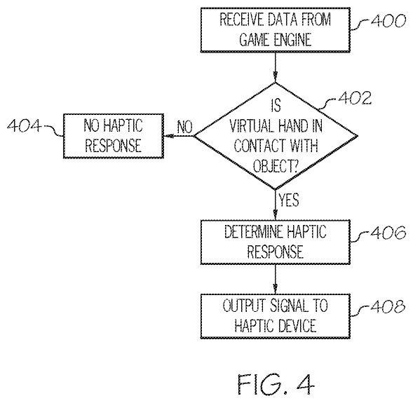

FIG. 4 depicts a flowchart of another example method of operating the haptic engine 270, according to one or more embodiments shown and described herein. At step 400, the collider data reception module 272 receives first data from the game engine 250. The first data comprises data from one or more colliders associated with a virtual hand in a virtual world. In some examples, the collider data reception module 272 may receive the first data from the haptic engine plugin 260. In these examples, the haptic engine plugin 260 may be configured to receive the data from the one or more colliders associated with the virtual hand in the virtual world (e.g., from the game engine 250) and output the first data. The object parameter reception module 274 may also receive haptic parameters associated with an object in the virtual world.

At step 402, the contact determination module 278 determines whether the virtual hand is making contact with a virtual object in the virtual world based on the first data. When it is determined that the virtual hand is making contact with the virtual object (yes, at step 402), control passes to step 406. When it is determined that the virtual hand is not making contact with the virtual object (no at step 402), control passes to step 404 and no haptic response is produced.

At step 406, the haptics determination module 280 determines a haptic response based on the first data and one or more parameters associated with the virtual object. The parameters associated with the virtual object may comprise user definable material properties of the virtual object.

At step 408, the haptic data output module 282 outputs second data to cause a wearable haptic device (e.g., the haptic glove 106) to create the haptic response. In some examples, the haptic data output module 282 outputs the second data to a haptic device driver associated with the wearable haptic device (e.g., the haptic driver 110). The haptic device driver may be configured to cause the wearable haptic device to create the haptic response after receiving the second data.

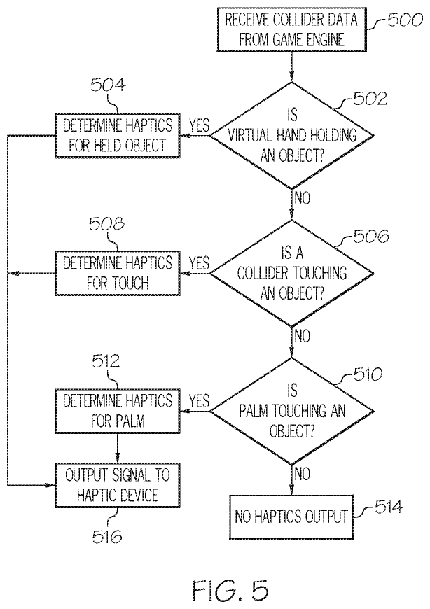

FIG. 5 depicts a flowchart of another example method of operating the haptic engine 270, according to one or more embodiments shown and described herein. At step 500, the collider data reception module 272 receives collider data from the game engine 250 or from the haptic engine plugin 260. The collider data may be associated with a collision between a virtual character (e.g., a virtual hand of the virtual character) and one or more virtual objects in a virtual world. The object parameter reception module 274 may also receive haptic parameters associated with the one or more virtual objects in the virtual world.

At step 502, the grasp determination module 276 determines whether the virtual hand is holding an object based on the collider data received by the collider data reception module 272. If the grasp determination module 276 determines that the virtual hand is holding an object (yes at step 502), then at step 504, the haptics determination module 280 determines a haptic response for the object being held based on the collider data received by the collider data reception module 272. If the grasp determination module 276 determines that the virtual hand is not holding an object (no at step 502), then control passes to step 506.

At step 506, the contact determination module 278 determines whether the fingers of the virtual hand are touching an object based on the collider data received by the collider data reception module 272. If the contact determination module 278 determines that the fingers of the virtual hand are touching an object (yes at step 506), then at step 508, the haptics determination module 280 determines a haptic response for the objects touching the fingers of the virtual hand based on the collider data received by the collider data reception module 272. If the contact determination module 278 determines that the fingers of the virtual hand are not touching an object (no at step 506), then control passes to step 510.

At step 510, the contact determination module 278 determines whether the palm of the virtual hand is touching an object based on the collider data received by the collider data reception module 272. If the contact determination module 278 determines that the palm of the virtual hand is touching an object (yes at step 510), then at step 512, the haptics determination module 280 determines a haptic response for the object touching the palm of the virtual hand based on the collider data received by the collider data reception module 272. If the contact determination module 278 determines that the palm of the virtual hand is not touching an object (no at step 510), then at step 514, no haptics are output to the haptic glove 106.

After the haptics determination module 280 determines a haptic response at step 504, step 508, or step 512, then at step 516, the haptic data output module 282 outputs a signal to the haptic driver 110 of the haptic glove 106 to cause the electro-mechanical components 112 to actuate to cause the haptic glove 106 to produce the haptic response determined by the haptics determination module 280.

It should be understood that embodiments described herein are directed to a haptic engine for controlling haptics for wearable or non-wearable haptic device. The haptic device may be used to control a virtual character in a game or virtual world. The game or virtual world is run by a game engine and one or more aspects of a virtual character in the virtual world may be controlled by a user using the haptic device.

One or more colliders may be positioned at certain locations on the virtual character. The virtual character may interact with virtual objects in the virtual world that may also have colliders positioned on them. When the virtual character interacts with objects in the virtual world, one or more colliders of the virtual character may collide with one or more colliders of a virtual object and the game engine may transmit collider data associated with the collision to a haptic engine plugin. The game engine may also output haptic parameters associated with the object involved in the collision to the haptic engine plugin.

The haptic engine plugin may receive the collider data and haptic parameters from the game engine and may convert the collider data and haptic parameters to a format understood by the haptic engine. The haptic engine plugin may then transmit the collider data and haptic parameters in the converted data format to the haptic engine.

The haptic engine may receive the collider data and haptic parameters from the haptic engine plugin and may determine a haptic response to be produced based on the received collider data and haptic parameters. The haptic engine may then output a signal to a haptic driver of the haptic device to cause the haptic device to produce the desired haptic response.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving data from a game engine associated with one or more virtual interactions in a virtual world;
determining a haptic response based on the virtual interactions; and
outputting a signal to a haptic device to cause the haptic device to create the haptic response.

2. The method of claim 1, wherein the haptic response comprises vibration.

3. The method of claim 1, wherein the haptic response comprises force feedback.

4. The method of claim 1, wherein the haptic response comprises applying a temperature or temperature change.

5. The method of claim 1, wherein the haptic response comprises causing the haptic device to apply pressure to a wearer of the haptic device at one or more points on the haptic device.

6. The method of claim 1, wherein the haptic device comprises a glove and the signal causes the haptic device to create the haptic response on one or more fingers of the glove.

7. The method of claim 1, wherein the haptic device comprises a glove and the signal causes the haptic device to create the haptic response on a palm of the glove.

8. The method of claim 1, wherein at least one of the virtual interactions in the virtual world comprises a collision between a virtual hand and a virtual object.

9. The method of claim 8, wherein the data from the game engine comprises metadata associated with the virtual object.

10. The method of claim 9, wherein the metadata associated with the virtual object comprises one or more material properties of the virtual object.

11. The method of claim 1, wherein the data from the game engine comprises data from one or more colliders associated with a virtual hand in the virtual world.

12. A method comprising:
receiving first data from a game engine, the first data comprising data from one or more colliders associated with a virtual hand in a virtual world;
determining whether the virtual hand is making contact with a virtual object in the virtual world based on the first data; and
when it is determined that the virtual hand is making contact with the virtual object,
determining a haptic response based on the first data and one or more parameters associated with the virtual object; and
outputting second data to cause a wearable haptic device to create the haptic response.

13. The method of claim 12, wherein the one or more parameters associated with the virtual object comprise user definable material properties of the virtual object.

14. The method of claim 12, further comprising:
outputting the second data to a haptic device driver associated with the wearable haptic device, wherein the haptic device driver is configured to cause the wearable haptic device to create the haptic response after receiving the second data.

15. The method of claim 12, further comprising:
receiving the first data from a haptic engine plugin associated with the game engine, wherein the haptic engine plugin is configured to receive the data from the one or more colliders associated with the virtual hand in the virtual world and output the first data.

16. A system comprising:
a haptic device;
a game engine;
a haptic engine plugin;
a haptic engine;
one or more processors;
one or more memory modules; and
machine readable instructions stored in the one or more memory modules that, when executed by the one or more processors, cause the haptic engine to:
receive data from the haptic engine plugin associated with one or more virtual interactions in a virtual world based on data transmitted from the game engine to the haptic engine plugin;
determine a haptic response based on the virtual interactions; and
output a signal to the haptic device to cause the haptic device to create the haptic response.

17. The system of claim 16, wherein the machine readable instructions, when executed by the one or more processors, cause the haptic engine to:
receive data from the haptic engine plugin comprising data associated with colliders associated with a virtual hand in the virtual world.

18. The system of claim 17, wherein the data from the haptic engine plugin comprises a collision between the virtual hand and a virtual object in the virtual world.

19. The system of claim 18, wherein:
the data from the haptic engine plugin comprises metadata associated with the virtual object; and
the signal causes the haptic device to create the haptic response based on the metadata.

20. The system of claim 19, wherein the metadata comprises one or more material properties of the virtual object.
